(19) United States
(12) Patent Application Publication
(10) Pub. No.: US 2014/0362581 A1
(43) Pub. Date: Dec. 11, 2014

(54) LIGHT EMITTING DIODE ASSEMBLY WITH AN INTERNAL PROTRUSION PROVIDING REFRACTION AND HEAT TRANSFER

(71) Applicants: Tom KIM, Troy, MI (US); Joseph ZAKAR, Troy, MI (US)

(72) Inventors: Tom KIM, Troy, MI (US); Joseph ZAKAR, Troy, MI (US)

(21) Appl. No.: 13/910,588

(22) Filed: Jun. 5, 2013

(51) Int. Cl. F21V 29/00; F21K 99/00; F21V 5/04

(52) U.S. Cl. CPC F21V 29/22; F21V 5/045; F21K 9/13
USPC 362/294

(57) ABSTRACT

A light emitting diode (LED) bulb assembly including a bulb enclosure having a wall defining an open end and forming a cavity. The wall has an inner surface, an outer surface, and defining an elongate protrusion extending outwardly from an opposite end inwardly into the cavity toward the open end for a distance at least half way to the open end. The protrusion increases an area of both the inner surface and the outer surface for increased heat transfer capability and for refraction of light directed toward the protrusion. The protrusion has a diminishing cross sectional periphery along a longitudinal axis of the protrusion in a relationship to a distance from the opposite end toward the open end. At least one LED mount mounted by a base supports at least one LED disposed within the cavity. The bulb enclosure sealingly connects to the base at the open end.

### FIELD OF THE INVENTION

The present invention relates to an LED bulb assembly and more particularly to an LED bulb assembly with heat transfer and refraction of light capability.

### BACKGROUND

Light emitting diodes (LEDs) are becoming more common and widespread in use due to the low power consumption and long lifespan. However, LEDs also have limited temperature tolerance as compared to incandescent bulbs. As the temperature of the LEDs rises, this results in lower efficiency and degradation. Heat dissipation techniques such as rods, radiators, and heat sinks are often employed in LED bulb assemblies to combat this problem, but the total LED power that can be fitted into an assembly remains limited by the heat dissipation technique employed. Additionally, the light from an LED is largely directional making LEDs less ideal for broad illumination applications. Consequently, LED bulb manufactures have sought to include larger LEDs or a design with several LEDs in a package to combat the directional problem, while subsequently adding to the heat dissipation needs.

U.S. Pat. No. 7,878,697 B2 discloses an axial thermal conductor nearby the light source module extending into a liquid along an axial direction of the cavity to evenly transfer heat from the light source module through the liquid to the container. The axial thermal conductor is not light reflecting and is not transparent causing a dead zone in the light reflection.

U.S. Pat. No. 8,277,094 B2 discloses a liquid-volume compensator mechanism that moves from a first position to a second position to compensate for expansion of a thermally conductive liquid. The volume compensator mechanism does not assist in the refraction of light. The bulb shape is limited to globular, tubular, or spherical due to the size of the volume compensator mechanism.

U.S. Patent Application Publication 2012/0243235 A1 discloses a decorative LED lamp with a reflector placed at an adjustable distance above an LED to adjust the light distribution of the LED. The LED lamp contemplates only a heat sink for heat dissipation. The LED lamp does not contemplate a heat dissipation solution involving increased surface area of the bulb enclosure.

U.S. Pat. No. 8,324,790 discloses a high illumination LED bulb including a transparent lamp holder and a transparent reflective envelope coated with a reflective membrane having light transmittance characteristics. The LED bulb contemplates a radiator for heat dissipation. The LED bulb does not contemplate a heat dissipation solution involving increased surface area of the bulb enclosure.

U.S. Pat. No. 8,292,468 B2 discloses a solid state light bulb having a light source and heat sink at the apex of the light bulb envelope, distant from the lamp base, in order to dissipate heat produced by the light source into the environment. The bulb does not contemplate other heat dissipating means other than a heat sink. The light reflector is not part of the bulb envelope and may be of different material altogether.

It would be desirable to provide an LED bulb assembly that increases heat transfer capability while simultaneously increasing the refraction of light.

### SUMMARY

A light emitting diode (LED) bulb assembly can include a bulb enclosure having a wall defining an open end and forming a cavity. The wall can have an inner surface, an outer surface, and can define an elongate protrusion extending from an opposite end with respect to the open end and extending inwardly into the cavity toward the open end for a distance at least half way to the open end. The protrusion can increase an area of both the inner surface and the outer surface for increased heat transfer capability and for refraction of light directed toward the protrusion. The protrusion can have a diminishing cross sectional periphery along a longitudinal axis of the protrusion in a relationship to a distance from the opposite end toward the open end. At least one LED mount can be mounted by a base to support at least one LED disposed within the cavity. The bulb enclosure can be sealingly connected to the base at the open end. The protrusion can extend into the cavity in a direction toward the at least one LED.

A light emitting diode (LED) bulb assembly can include a bulb enclosure having a wall defining an open end and forming a cavity. The wall can have an inner surface, an outer surface, and can define an elongate protrusion extending from an opposite end with respect to the open end and extending inwardly into the cavity toward the open end for a distance at least half way to the open end. The protrusion can increase an area of both the inner surface and the outer surface for increased heat transfer capability and for refraction of light directed toward the protrusion. The protrusion can have a diminishing cross sectional periphery along a longitudinal axis of the protrusion in a relationship to a distance from the opposite end toward the open end. The bulb enclosure can be formed of frosted glass and the protrusion can be conical shaped. At least one LED mount can be mounted by a base to support at least one LED disposed within the cavity. A thermally conductive liquid can at least partially fill the cavity for heat dissipation. The thermally conductive liquid can be a vegetable glycerin. At least one diaphragm can be disposed within the cavity for thermal expansion and contraction of the thermally conductive liquid. The bulb enclosure can be sealingly connected to the base at the open end. The protrusion can extend into the cavity in a direction toward the at least one LED.

A light emitting diode (LED) bulb assembly can include a bulb enclosure having a wall defining an open end and forming a cavity. The wall can have an inner surface, an outer surface, and can define an elongate protrusion extending from an opposite end with respect to the open end and extending inwardly into the cavity toward the open end for a distance at least half way to the open end. The protrusion can increase an area of both the inner surface and the outer surface for increased heat transfer capability and for refraction of light directed toward the protrusion. The protrusion can have a diminishing cross sectional periphery along a longitudinal axis of the protrusion in a relationship to a distance from the opposite end toward the open end. The bulb enclosure can be formed of frosted glass and the bulb enclosure can be formed as a Fresnel lens. At least one LED mount can be mounted by a base to support at least one LED disposed within the cavity. At least one LED can be an alternating current (AC) LED. A thermally conductive liquid can at least partially fill the cavity for heat dissipation. The thermally conductive liquid can be a vegetable glycerin. At least one diaphragm can be disposed within the cavity for thermal expansion and contraction of the thermally conductive liquid. The bulb enclosure can be sealingly connected to the base at the open end. The protrusion can extend into the cavity in a direction toward the at least one LED.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a top view illustration of an LED bulb assembly including a bulb enclosure having a wall defining an open end and forming a cavity with an inner surface and an outer surface;

FIG. 2 is a side view illustration of the LED bulb assembly of FIG. 1;

FIG. 3 is a side view illustration of an LED bulb assembly including a bulb enclosure having a wall defining an open end and forming a cavity with an inner surface and an outer surface; and

FIG. 4 is a top view illustration of the LED bulb assembly of FIG. 3.

### DETAILED DESCRIPTION

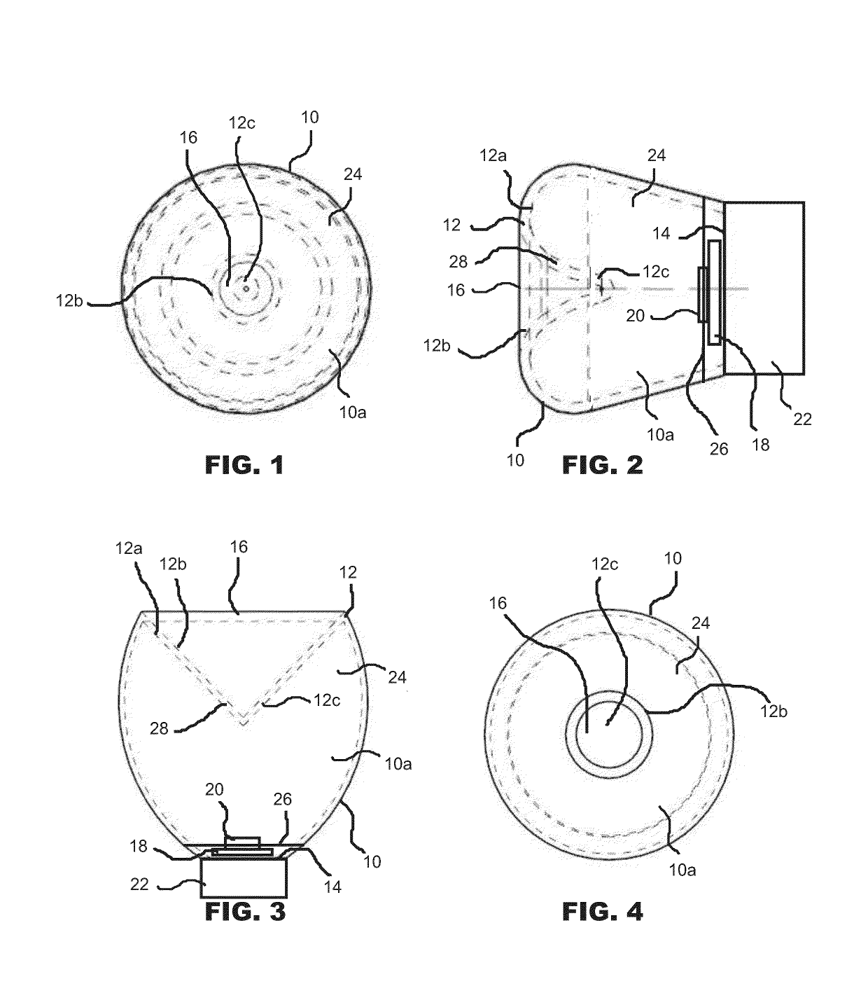

Referring now to FIGS. 1 and 4, by way of example and not limitation, top views illustrate exemplary configurations for a light emitting diode (LED) bulb assembly including a bulb enclosure 10 having a wall 12 defining an open end 14 and forming a cavity 10a. The top view of the bulb enclosure 10 illustrated in FIGS. 1 and 4 are round. However, it should be recognized that the bulb enclosure 10 is not limited to a specific shape, such as that illustrated in FIGS. 1 and 4. Rather, the bulb enclosure 10 can be, by way of example and not limitation, spherical, aspherical, round, tubular, n-sided, rectangular, oval, square, or any other shape. Likewise, the bulb enclosure 10 is not limited to a specific material and can be made of any suitable material, by way of example and not limitation, such as glass, plastic, polycarbonate, or other suitable material or a combination of materials. The bulb enclosure 10 material chosen can be dependent on any light emitting properties desired. A material of higher transparency can allow a greater amount of light to pass through, while a lesser transparent material can allow less light to penetrate the bulb enclosure 10.

Referring now to FIGS. 2 and 3, the wall 12 can have an inner surface 12a, an outer surface 12b, and can define an elongate protrusion 12c extending from an opposite end 16 with respect to the open end 14 and extending inwardly into the cavity 10a toward the open end 14 for a distance at least half way to the open end 14. The elongate protrusion 12c can have a diminishing cross sectional periphery along a longitudinal axis of the protrusion 12c in a relationship to a distance from the opposite end 16 toward the open end 14. The protrusion 12c extends into the cavity 10a in a direction toward the at least one LED 20. The inner surface 12a of the wall 12 can define the outline and outer border of the cavity 10a. The elongate protrusion 12c can extend into the cavity increasing both the inner surface 12a of the wall 12 and the outer surface 12b of the wall 12. The inner surface 12a surface area can increase with the size of the elongate protrusion 12c. The elongate protrusion 12c can increase an area of both the inner surface 12a and the outer surface 12b for increased heat transfer capability and for refraction of light directed toward the elongate protrusion 12c. The shape of the elongated protrusion 12c, by way of example and not limitation, can be conical, as shown in FIG. 3. By way of example and not limitation, in another configuration, as shown in FIG. 2, the protrusion 12c can be a rounder conical shape. It should be recognized that the protrusion 12c can be of any shape, where the protrusion 12c extends from an opposite end 16 with respect to the open end 14 and extends inwardly into the cavity 10a toward the open end 14 for a distance at least half way to the open end 14.

The protrusion 12c can have a reflective surface coating 28 formed on at least one of the inner surface 12a and the outer surface 12b. By way of example and not limitation, it is contemplated that the bulb enclosure 10 can be covered either fully or partially by a reflective surface coating 28.

The protrusion 12c can have a translucent surface coating 28 formed on at least one of the inner surface 12a and the outer surface 12b. By way of example and not limitation, it is contemplated that the translucent coating 28 can cover the entire bulb enclosure 10, or the translucent coating 28 can cover only a portion of the bulb enclosure 10, or the bulb enclosure 10 can have no translucent coating 28, if desired.

By way of example and not limitation, it is contemplated that the bulb enclosure 10 can be formed of frosted glass, or the bulb enclosure 10 can be formed of frosted glass and have a conical shaped elongated protrusion 12c. The bulb enclosure 10 can also be formed as a Fresnel lens, if desired.

Referring now to FIG. 2, a side view illustration of the LED bulb assembly of FIG. 1 is shown. Various configurations of the bulb enclosure 10 at the area of the opposite end 16 are contemplated. The shape of the bulb enclosure 10 at the opposite end 16 can be defined by the wall 12 of the elongate protrusion 12c as shown in FIGS. 1 and 2. In this respect, the bulb enclosure 10 can be of a shape directly relative to the wall 12 of the elongate protrusion 12c. Alternatively, the bulb enclosure 10 shape can be of a form irrespective of the elongate protrusion 12c, as shown in the embodiment of FIG. 3. In FIG. 3, the wall 12 of the elongate protrusion 12c can be enclosed within the bulb enclosure 10 at the area of the opposite end 16.

At least one LED mount 18 can be mounted by a base 22 to support at least one LED 20 disposed within the cavity 10a. A single LED mount 18 and LED 20 is illustrated in FIGS. 2 and 3. By way of example and not limitation, it should be recognized that a plurality of LED mounts 18 and plurality of LEDs 20 can be disposed within the cavity 10a, if desired. The LED mount 18 can support a single LED 20, or can support the mounting of a plurality of LEDs 20. At least one LED 20 can be an alternating current (AC) LED 20. An AC LED 20 can provide higher power output without the need for a driver chip to convert an input voltage from AC to direct current (DC). By way of example and not limitation, it is contemplated that at least one LED 20 can be a DC LED 20, or an AC LED 20, or any combination thereof if desired.

The bulb enclosure 10 can be sealingly connected to the base 22 at the open end 14. In applications where greater temperature control and heat dissipation are required or desired, a thermally conductive liquid 24 can be provided at least partially filling the cavity 10a for heat dissipation of the LED 20. The thermally conductive liquid 24 can be an environmentally friendly vegetable glycerin. By way of example and not limitation, it should be recognized that other thermally conductive liquids 24 can suffice and the present disclosure is not limited to a vegetable glycerin material. The connector base 22 can seal the liquid 24 into the cavity 10a of the bulb enclosure 10. A seal between the base 22 and the bulb enclosure 10 can be used to prevent leakage of the liquid 24. The base 22 can allow insertion into a lighting fixture or lighting socket. The base 22 can connect to a lighting socket directly or through a type of attachment.

In applications where greater temperature control and heat dissipation entails the use of a thermally conductive liquid 24 encased within the bulb enclosure 10, at least one diaphragm 26 can be disposed within the cavity 10a for thermal expansion and contraction of the thermally conductive liquid 24. Referring now to FIG. 3, a diaphragm 26 can be positioned just below the at least one LED 20 and above the at least one LED mount 18. Positioning the diaphragm 26 below the LED 20 allows the LED to emit light and dissipate heat through the thermally conductive liquid 24. Referring now to FIG. 2, the diaphragm 26 can be positioned in the middle of the LED 20. The position of the at least one diaphragm 26 can be selected to allow the LED 20 to be immersed in the thermally conductive liquid 24. However, it should be recognized that the at least one diaphragm 26 can be located in other positions within the cavity 10a, if desired.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A light emitting diode (LED) bulb assembly comprising:
a bulb enclosure (10) having a wall (12) defining an open end (14) and forming a cavity (10a), the wall (12) having an inner surface (12a), an outer surface (12b), and defining an elongate protrusion (12c) extending outwardly from an opposite end (16) inwardly into the cavity (10a) toward the open end (14) for a distance at least half way to the open end (14), the protrusion increasing an area of both the inner surface (12a) and the outer surface (12b) for increased heat transfer capability and for refraction of light directed toward the protrusion (12c), the protrusion (12c) having a diminishing cross sectional periphery along a longitudinal axis of the protrusion (12c) in a relationship to the distance from the opposite end (16) toward the open end (14);
at least one LED mount (18) supporting at least one LED (20) disposed within the cavity (10a); and
a base (22) located adjacent to the at least one LED mount (18), the bulb enclosure (10) sealingly adjoined to the base (22) at the open end (14), the protrusion (12c) extending into the cavity (10a) in a direction toward the at least one LED (20).

2. The assembly of claim 1 further comprising:
a thermally conductive liquid (24) at least partially filling the cavity (10a) for heat dissipation.

3. The assembly of claim 2 further comprising:
at least one diaphragm (26) disposed within the cavity (10a) for thermal expansion and contraction of the thermally conductive liquid (24).

4. The assembly of claim 2, wherein the thermally conductive liquid (24) is vegetable glycerin.

5. The assembly of claim 1, wherein the protrusion (12c) is conical shaped.

6. The assembly of claim 1, wherein the protrusion (12c) has a reflective surface coating (28) formed on at least one of the inner surface (12a) and the outer surface (12b).

7. The assembly of claim 1, wherein the protrusion (12c) has a translucent surface coating (28) formed on at least one of the inner surface (12a) and the outer surface (12b).

8. The assembly of claim 1, wherein the at least one LED (20) is an alternating current (AC) LED.

9. The assembly of claim 1, wherein the at least one LED (20) is a direct current (DC) LED.

10. The assembly of claim 1, wherein the bulb enclosure (10) is formed of frosted glass.

11. The assembly of claim 1, wherein the bulb enclosure (10) is formed as a Fresnel lens.

12. A light emitting diode (LED) bulb assembly comprising:
a bulb enclosure (10) having a wall (12) defining an open end (14) and forming a cavity (10a), the wall (12) having an inner surface (12a), an outer surface (12b), and defining an elongate protrusion (12c) extending outwardly from an opposite end (16) inwardly into the cavity (10a) toward the open end (14) for a distance at least half way to the open end (14), the protrusion increasing an area of both the inner surface (12a) and the outer surface (12b) for increased heat transfer capability and for refraction of light directed toward the protrusion (12c), the protrusion (12c) having a diminishing cross sectional periphery along a longitudinal axis of the protrusion (12c) in a relationship to the distance from the opposite end (16) toward the open end (14), wherein the bulb enclosure (10) is formed of frosted glass and the protrusion (12c) is conical shaped;
at least one LED mount (18) supporting at least one LED (20) disposed within the cavity (10a);
a thermally conductive liquid (24) at least partially filling the cavity (10a) for heat dissipation, wherein the thermally conductive liquid (24) is vegetable glycerin;
at least one diaphragm (26) disposed within the cavity (10a) for thermal expansion and contraction of the thermally conductive liquid (24); and
a base (22) located adjacent to the at least one LED mount (18), the bulb enclosure (10) sealingly adjoined to the base (22) at the open end (14), the protrusion (12c) extending into the cavity (10a) in a direction toward the at least one LED (20).

13. The assembly of claim 12, wherein the at least one LED (20) is an alternating current (AC) LED.

14. The assembly of claim 13, wherein the protrusion (12c) has a reflective surface coating (28) formed on at least one of the inner surface (12a) and the outer surface (12b).

15. The assembly of claim 13, wherein the protrusion (12c) has a translucent surface coating (28) formed on at least one of the inner surface (12a) and the outer surface (12b).

16. The assembly of claim 12, wherein the at least one LED (20) is a direct current (DC) LED.

17. The assembly of claim 12, wherein the bulb enclosure (10) is formed as a Fresnel lens.

18. A light emitting diode (LED) bulb assembly comprising:
a bulb enclosure (10) having a wall (12) defining an open end (14) and forming a cavity (10a), the wall (12) having an inner surface (12a), an outer surface (12b), and defining an elongate protrusion (12c) extending outwardly from an opposite end (16) inwardly into the cavity (10a) toward the open end (14) for a distance at least half way to the open end (14), the protrusion increasing an area of both the inner surface (12a) and the outer surface (12b) for increased heat transfer capability and for refraction of light directed toward the protrusion (12c), the protrusion (12c) having a diminishing cross sectional periphery along a longitudinal axis of the protrusion (12c) in a relationship to the distance from the opposite end (16) toward the open end (14), wherein the protrusion (12c) is conical shaped, the bulb enclosure (10) is formed of frosted glass, and the bulb enclosure (10) is formed as a Fresnel lens;
at least one LED mount (18) supporting at least one LED (20) disposed within the cavity (10a), wherein the at least one LED (20) is an alternating current (AC) LED;
a thermally conductive liquid (24) at least partially filling the cavity (10a) for heat dissipation, wherein the thermally conductive liquid (24) is vegetable glycerin;
at least one diaphragm (26) disposed within the cavity (10a) for thermal expansion and contraction of the thermally conductive liquid (24); and
a base (22) located adjacent to the at least one LED mount (18), the bulb enclosure (10) sealingly adjoined to the base (22) at the open end (14), the protrusion (12c) extending into the cavity (10a) in a direction toward the at least one LED (20).

19. The assembly of claim 18, wherein the protrusion (12c) has a reflective surface coating (28) formed on at least one of the inner surface (12a) and the outer surface (12b).

20. The assembly of claim 18, wherein the protrusion (12c) has a translucent surface coating (28) formed on at least one of the inner surface (12a) and the outer surface (12b).
